(19) United States
(12) Patent Application Publication
(10) Pub. No.: US 2023/0110273 A1
(43) Pub. Date: Apr. 13, 2023

(54) VALVE AND USE OF A DAMPING DEVICE

(71) Applicant: Neoperl GmbH, Müllheim (DE)

(72) Inventor: Marc TEMPEL, Freiburg (DE)

(73) Assignee: Neoperl GmbH, Müllheim (DE)

(21) Appl. No.: 17/913,330

(22) PCT Filed: Feb. 22, 2021
(86) PCT No.: PCT/EP2021/054341

§ 371 Date: Sep. 21, 2022

(30) Foreign Application Priority Data
Apr. 9, 2020 (DE) 202020101991.0

(51) Int. Cl. F16K 47/00; F16K 31/56; F16K 31/524

(52) U.S. Cl. CPC F16K 47/011; F16K 31/56; F16K 31/52408; E03C 2001/026

(57) ABSTRACT

A valve (1), in particular a piston valve, including a stationary housing part (2) and an actuating element (3) which can be adjusted relative to the housing part (2) and is in, or can be brought into, an operative connection with a valve body (4). The valve body (4) can be adjusted by way of actuation of the actuating element (3) between an open position which opens an outlet (5) and a closed position which closes the outlet (5). The valve (1) has a damping device (6) for extending a closing time of the valve (1), by an adjusting force which is applied for the closure of the valve (1) being opposed by a damping force which is produced by way of the damping device.

### CROSS-REFERENCE TO RELATED APPLICATIONS

This application is the U.S. National Phase of PCT Appin. No. PCT/EP2021/054341, filed Feb. 22, 2021, which claims the benefit of German Patent Appin. No. 20 2020 101 991.0, filed Apr. 9, 2020, the entire disclosures of which are incorporated by reference herein.

### TECHNICAL FIELD

The invention relates to a valve, in particular a piston valve, comprising a stationary housing part and an actuating element which can be adjusted relative to the housing part and which is in an operative connection with a valve body, wherein the valve body can be adjusted by way of actuation of the actuating element between an open position which opens an outlet and a closed position which closes the outlet.

### BACKGROUND

Valves of the type mentioned in the introduction are disclosed in DE 21 47 187 A1, DE 20 2016 001236 U1 and JP S55 50350 U2 and are used, for example, in the sanitary field. Said valves can also be used to regulate a water outlet, by the water outlet being closable or openable by means of the valve.

Tests on previously known valves of the type mentioned in the introduction have revealed that pressure surges which are more than three times greater than a permitted maximum value can occur when the valve is being closed. According to DIN EN 15091:2014-03 a permitted maximum value of a pressure surge of 8 bar is possible with a flow rate of 23 liters per minute at 5 bar. However, pressure surges of up to 25 bar have been measured.

### SUMMARY

The object of the invention, therefore, is to provide a valve of the type mentioned in the introduction which fulfills the values of a pressure surge predetermined by DIN EN 15091:2014-03.

The object is achieved according to the invention by a valve having one or more of the features disclosed herein.

In particular, a valve of the type mentioned in the introduction is proposed according to the invention in order to achieve the object, said valve being characterized in that the valve has a damping device with a damping element which can be adjusted relative to the actuating element and/or the stationary housing part, in that at least a restoration of the valve body from the open position into the closed position is damped by the damping device. Thus when the valve is being closed at least a reduction in an occurring pressure surge can be achieved, such that in particular the specifications according to DIN EN 15091:2014-03 are fulfilled. Valves of the type mentioned in the introduction are generally rapidly closed. It has been shown by tests that relatively high pressure surges can occur due to a relatively abrupt restoration of the valve body from the open position into the closed position. By extending the closing time of the valve achieved by means of the damping device, such high pressure surges no longer occur.

The term “stationary” can refer, for example, to an installed situation. If the valve is inserted into a corresponding valve receiver, the stationary housing part is not adjusted relative to the valve receiver when the valve is actuated.

Moreover, a valve of the type mentioned in the introduction is proposed according to the invention in order to achieve the object, such that at least in an open position the damping element is spaced apart from a stop formed by the stationary housing part. Alternatively or additionally, at least in a closed position the damping element can bear against a stop formed by the stationary housing part. Thus when the valve body is restored, the damping device and, in particular, the damping element can be restored as far as the stop until the damping element finally bears against the stop. In order to achieve a complete closure of the valve, the damping element now has to be pushed against the stop and at the same time is moved relative to the damping chamber. In this case, the damping element is retracted counter to a damping force generated by the damping device. Thus the closing time of the valve can be increased, such that the valve body is adjusted more slowly into the valve seat.

Advantageous embodiments of the invention which can be optionally combined, individually or in combination with the features of other embodiments, with the features noted above are described hereinafter.

According to an advantageous development, the damping device can have a damping chamber in which the damping element is arranged. The damping element can be configured, for example, as an axially adjustable damping piston. In particular, the damping element can divide the damping chamber into two sub-chambers, wherein the respective volumes thereof are able to be changed as a function of the closed position and/or the open position of the valve. In other words, the damping element can be adjusted inside the damping chamber. Thus it is possible to generate a damping force which at least during a closing process of the valve counteracts the adjusting force acting on the valve body. By means of the damping device, therefore, it is possible to create a resistance against which the valve body has to be adjusted. As a result, at least the closing time of the valve can be increased and pressure surges reduced.

In order to permit a simple opening and closing of the valve, the valve can have a push-push adjusting mechanism which can be actuated by the actuating element. In particular, a bistable adjustment of the valve body can take place between the open position and the closed position, in each case by pushing the actuating element. Thus, on the one hand, the operation of the valve is simplified and, on the other hand, it is almost impossible for a user to operate the valve incorrectly. It can also be provided that more than two bistable positions can be set by means of the push-push adjusting mechanism, such that at least one intermediate position can be set between the maximum open position and the closed position with a reduced flow rate.

According to a particularly advantageous development, it can be provided that the damping device has a damping fluid, in particular an oil, which is displaceable or displaced by the damping element, at least when the valve body is restored from the open position into the closed position. Preferably, the damping fluid can be displaceable or displaced through a regulating gap and/or a bypass which preferably can be changed in terms of its size. Therefore, a resistance against which the damping element and/or the valve body is adjusted can be determined by the viscosity of the damping fluid and/or the size of the regulating gap and/or the size of the bypass. In particular, the damping fluid can be displaceable or displaced from one sub-chamber into the other sub-chamber of the damping chamber. The regulating gap can thus be configured between the sub-chambers. Alternatively or additionally, a bypass can be configured between the sub-chambers, said bypass remaining open irrespective of the direction of movement of the valve body, such that for example damping fluid flows through the bypass when the valve body is adjusted. According to a particularly preferred embodiment, the regulating gap preferably can be completely closed by a regulating element when the valve body is restored from the open position into the closed position, such that the damping fluid can flow exclusively through the bypass.

According to an advantageous development of the valve, it can be provided that a spring element is arranged inside the damping chamber, in particular inside a sub-chamber of the damping chamber, preferably said spring element being compressed in a closed position of the valve and/or being relaxed in an open position of the valve. During a closing process of the valve the damping element can be adjusted, in particular retracted, counter to the spring force of the spring element. During an opening process, the damping element can be extended again by the spring force of the spring element, if the spacing between the damping chamber and the stop increases.

According to an advantageous development, it can be provided that the valve has a restoring element which is arranged such that, when adjusted from the closed position into the open position, the valve body is adjustable or adjusted counter to the restoring force of the restoring element of the valve and/or that the valve body is restored from the open position into the closed position at least partially by the restoring force of the restoring element. The restoring element can be configured, for example, as a spring. Preferably, the restoring element can be supported on a stationary part, in particular on a, or the, stationary housing part, of the valve and on the valve body or at least in each case transmit a force thereto.

According to a further advantageous embodiment, the valve body can have a valve piston which in the closed position closes a valve seat of the valve and/or which in the open position is adjusted out of the valve seat in the direction of the outlet. Preferably, the valve seat can be opened and/or widened in the direction of the outlet. Thus an improved closure of the valve can be achieved.

In order to be able to set a damping force which is intended to increase the closing time at least during a closing process, the damping device can have at least one regulating element, by which a degree of opening of a regulating gap between two sub-chambers of a damping chamber, for example the aforementioned damping chamber, is changeable or changed as a function of the adjusting direction of the damping element and/or the valve body. Preferably, the regulating gap can be set such that the degree of opening of the regulating gap is less when the valve body is adjusted from the open position into the closed position than when the valve body is adjusted from the closed position into the open position. Thus a greater damping action can be set during a closing process than during an opening process. According to a particularly advantageous embodiment, the regulating gap can be completely closed when the valve body is moved from the open position into the closed position. With an adjustment from the closed position into the open position, it can be provided that the regulating element opens the regulating gap, in particular, such that the regulating gap is opened to a maximum. Preferably, the regulating body is configured as at least one O-ring.

According to the invention, it is provided that the valve body is in an operative connection with the damping device. The operative connection is set up such that the valve body adjustably acts on the damping device. Preferably, when the valve body is restored from the open position into the closed position, the damping element can be pushable or pushed by a force transmitted from the valve body to the damping device against a, or the, stop and/or the damping element can be adjustable or adjusted relative to the damping chamber. Thus the closing time of the valve can be set in a manner which is simple and constant.

According to a further advantageous embodiment, it can be provided that a valve seat, in particular the aforementioned valve seat, is arranged between an inlet space of a fluid and an outlet space of the fluid, wherein the valve seat opens in the direction of the outlet space, and wherein the valve body is guided through the inlet space, and in that the valve body is guided with its free end out of the outlet space, in particular is guided into an air-filled space in which atmospheric pressure prevails. Thus it is possible to be able to adjust the valve body without counterpressure from a line arranged downstream of the outlet.

According to an advantageous development, it can be provided that a boundary, in particular a distal boundary, of the outlet space is at least partially created via at least one outlet space seal. In particular, the outlet space seal can be arranged between a side wall of the valve body and an inner wall of the outlet space. Preferably, the outlet space seal can be arranged on the valve body and/or can be adjustable together with the valve body.

The invention further relates to the use of a damping device for the damped restoration of the valve body of a valve, as described and/or claimed herein, from the open position into the closed position in order to avoid pressure surges.

### BRIEF DESCRIPTION OF THE DRAWINGS

The invention is now described in more detail by way of several exemplary embodiments but is not limited to these exemplary embodiments. Further exemplary embodiments result from combining the features of individual or several claims with one another and/or with individual or several features of the exemplary embodiments.

In the drawings:

FIG. 1 shows a sectional view of a possible embodiment of a valve according to the invention, wherein the valve is shown in an open position in which the outlet is opened to a maximum, wherein the damping element is extended and is spaced apart from a stop of the stationary housing part,

FIG. 2 shows a sectional view of the possible embodiment of the valve according to the invention of FIG. 1, wherein the valve is shown in a partial open position during a closing process, wherein the damping element is partially retracted and bears against the stop of the stationary housing part,

FIG. 3 shows a sectional view of a possible embodiment of the valve according to the invention of FIGS. 1 and 2, wherein the valve is shown in a closed position in which the outlet is completely closed, wherein the damping element is retracted to a maximum and bears against the stop of the stationary housing part,

FIG. 4 shows a perspective view of the embodiment of the valve according to the invention according to FIGS. 1-3,

FIG. 5 shows an exploded view of the embodiment of the valve according to the invention according to FIGS. 1-4,

FIG. 6 shows a detailed view of a possible variant of a damping device,

FIG. 7 shows a sectional view of a further possible embodiment of a valve according to the invention, wherein the valve is shown in an open position in which the outlet is opened to a maximum, wherein the damping element is extended and is spaced part from a stop of the stationary housing part, wherein the variant shown is configured independently of counterpressure, by the valve body being guided out of the outlet space,

FIG. 8 shows a sectional view of the possible embodiment of the valve according to the invention of FIG. 7, wherein the valve is shown in a partial open position during a closing process, wherein the damping element is partially retracted and bears against the stop of the stationary housing part,

FIG. 9 shows a sectional view of a possible embodiment of the valve according to the invention of FIGS. 7 and 8, wherein the valve is shown in a closed position in which the outlet is completely closed, wherein the damping element is retracted to a maximum and bears against the stop of the stationary housing part.

### DETAILED DESCRIPTION

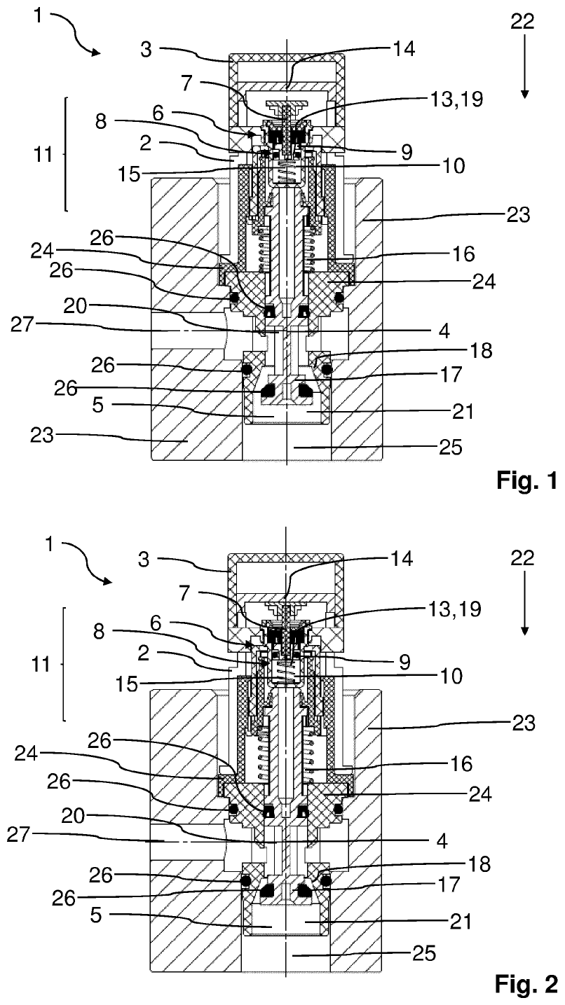

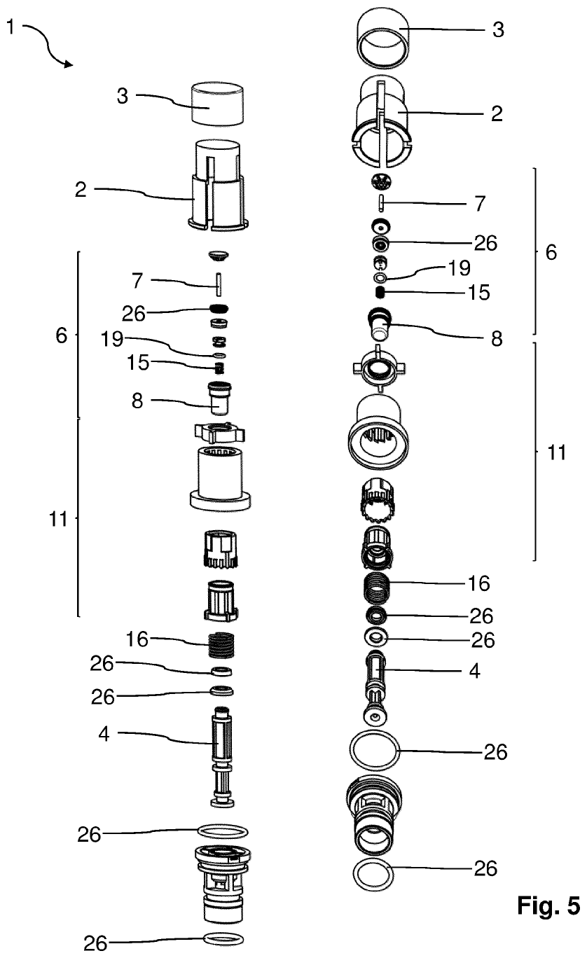

FIGS. 1-5 and FIGS. 7-9 in each case show a possible embodiment of a valve according to the invention which is denoted as a whole as 1. The invention, however, is not limited to these embodiments.

The valve 1 can be configured, for example, as a directly switchable piston valve.

In FIGS. 1-3 and 7-9 the valve 1 is shown in each case in a position of use in which it is inserted into a corresponding valve receiver 23 in order to separate an inflow 27 from an outflow 25. For example, the valve 1 can have a coupling point and the valve receiver 23 can have a counter-coupling point corresponding thereto.

The valve 1 has at least one stationary housing part 2 and an actuating element 3 which can be adjusted relative to the housing part 2.

The actuating element 3 can be designed to be able to be operated manually, for example as a push button.

The actuating element 3 can be actuated in order to be able to control an opening and a closing of the valve 1, wherein the actuating element 3 is in an operative connection with a valve body 4.

The valve body 4 can thus be adjusted, by way of actuation of the actuating element 3, between an open position which opens an outlet 5 and a closed position which closes the outlet 5.

During a switching process the valve body 4 can be decoupled from the actuating element 3 at least over a part of the adjusting path. Thus a relative movement is possible between the actuating element 3 and the valve body 4.

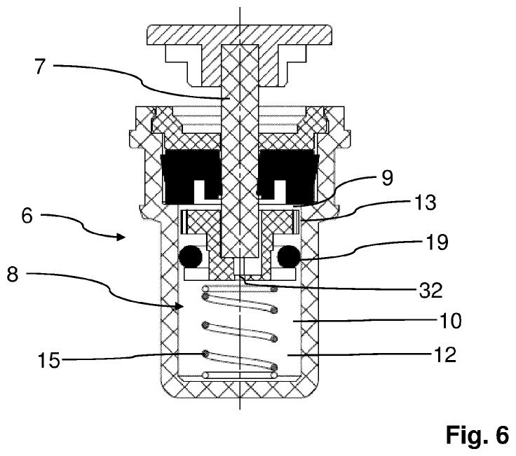

In order to be able to prevent a pressure surge, in particular when closing the valve 1, or at least to be able to reduce the intensity of a pressure surge, the valve 1 has a damping device 6 (see FIG. 6).

The damping device 6 is designed to reduce a closing speed of the valve body 4 during a closing process in order to increase the closing time relative to valves without a damping device 6.

The damping device 6 comprises at least one damping element 7 which can be adjusted relative to the actuating element 3 and/or the stationary housing part 2. A degree of damping can be set by the damping element 7, it being defined thereby how rapidly the valve body 4 is restored from the open position into the closed position.

Thus by means of the damping device 6 it is possible to prevent the formation of pressure surges at least when closing the valve 1, or to reduce an intensity of the pressure surges at least to a value which fulfills DIN EN 15091:2014-03.

The damping device 6 of the variants shown in FIGS. 1-5 and 7-9 in each case comprise a damping chamber 8 in which the damping element 7 is arranged. The damping element 7 and/or a regulating gap 13 can divide the damping chamber 8 into two sub-chambers 9, 10, wherein the respective volume thereof can be changed as a function of the closed position and/or open position of the valve 1.

The degree of opening of the regulating gap 13 can be changed by a regulating element 19. Preferably, the regulating element 19 can completely close the regulating gap 13 between the sub-chambers 9, 10, in particular when the valve body 4 is adjusted from the open position into the closed position. Thus when the damping element 7 is adjusted, the regulating element 19 can narrow or even completely close or open the regulating gap 13, depending on the direction in which the damping element 7 is adjusted.

The damping device 6 of FIG. 6 additionally has a bypass 32 which connects together the two sub-chambers 9, 10, in addition to the regulating gap 13, and permits a continuous flow rate of the damping fluid 12, irrespective of the direction in which the damping element 7 is moved. The degree of opening of the bypass 32 is thus irrespective of the regulating element 19 and/or constant. When the regulating gap 13 is completely closed, in particular when the valve body 4 is adjusted from the open position into the closed position, therefore, damping fluid can flow exclusively through the bypass 32.

In order to be able to set a bistable adjustment of the valve body 4, in particular in predefined end positions and/or at least one intermediate position, the valve 1 has a push-push adjusting mechanism 11 which can be actuated by the actuating element 3. Thus a bistable adjustment of the valve body 4 between the open position and the closed position is possible in each case by pushing the actuating element 3, wherein the push-push adjusting mechanism 11 is latched into a stable position in each case by pushing.

A damping fluid 12, such as for example an oil, can be arranged in the damping chamber 8. The damping fluid 12 can be displaced by the damping element 7 at least when the valve body 4 is restored from the open position into the closed position. Thus the degree of damping of the damping device 6 can be at least partially set by the viscosity of the damping fluid 12.

The damping device 6 has the regulating gap 13 through which the damping fluid 12 is displaceable or displaced when the valve body 4 is adjusted. Alternatively or additionally, the degree of damping can thus also be set by a degree of opening of the regulating gap 13. When the damping fluid 12 is displaced, this damping fluid is displaced from a first sub-chamber 9 into a second sub-chamber 10 or vice versa, depending on the direction of adjustment.

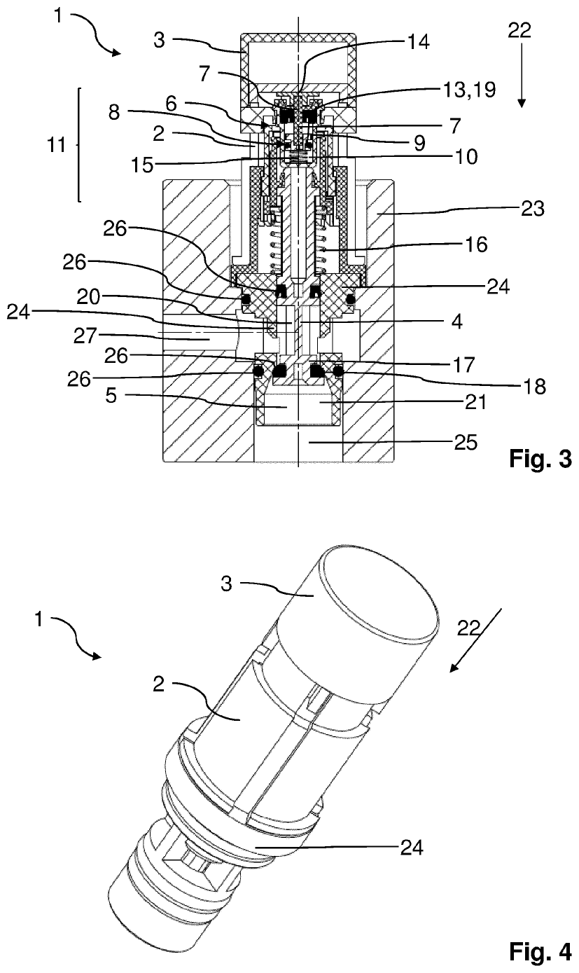

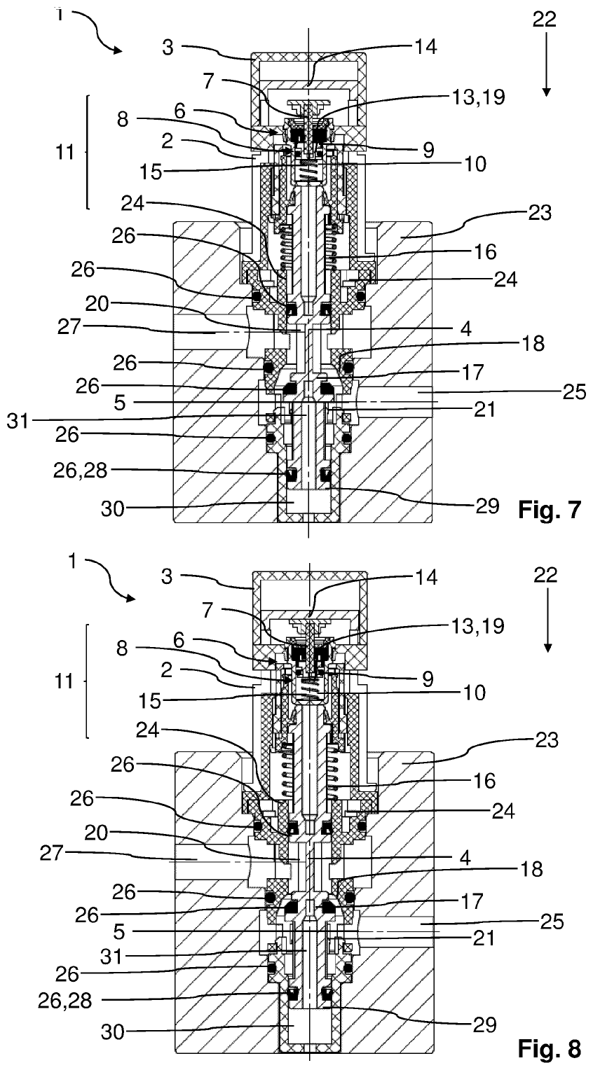

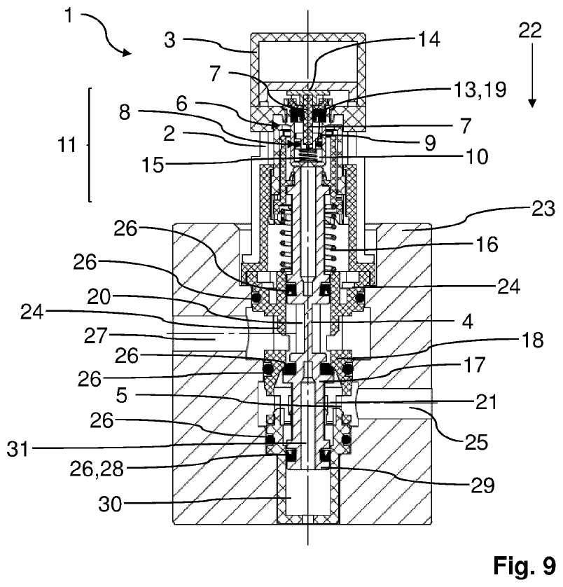

A stop 14 is configured on the stationary housing part 2, said stop being able to be acted upon by the damping element 7, in particular with a free end. If the valve 1 is in an open position the damping element 7 is spaced apart from the stop 14, as shown in FIGS. 1 and 7. During an opening process of the valve 1, the damping element 7 lifts away from the stop 14 and/or during a closing process it moves in the direction of the stop 14, as can be seen in FIGS. 2 and 8. If the valve 1 is finally in the closed position, as in FIGS. 3 and 9, the damping element 7 comes into contact with the stop 14 formed by the stationary housing part 2.

Alternatively or additionally, a spring element 15 can be arranged inside the damping chamber 8, said spring element being compressed in a closed position of the valve 1 and/or being relaxed in an open position of the valve 1. By means of the spring element 15, during an opening process of the valve 1 an extension of the damping element 7 can be achieved by means of a spring force generated thereby.

The valve 1 additionally has a restoring element 16 which is arranged such that a restoring force which can be generated thereby acts on the valve body 4, wherein the restoring force acts at least counter to the actuating direction 22 of the actuating element 3. When the valve body 4 is adjusted from the closed position into the open position, therefore, this takes place counter to the restoring force of the restoring element 16. When the actuating element 3 is actuated, the valve body 4 is restored from the open position into the closed position by the restoring element 16.

In order to be able to set a sealed closure of the valve 1, the valve body 4 has a valve piston 17 which in the closed position closes a valve seat 18 of the valve 1. At least one sealing element 26 can be arranged on the valve piston 17, said sealing element in the closed position bearing against the valve seat 18 and closing the opening of the valve seat 18 in a fluid-tight manner. In the open position, the valve piston 17 is at least partially spaced apart from the valve seat 18. The valve piston 17 is adjusted in the direction of the outlet 5 for opening the valve 1. The valve seat 18 thus opens in the direction of the outlet 5.

The damping device 6 has at least one regulating element 19, a degree of opening of the previously mentioned regulating gap 13 being changeable or changed thereby between the two sub-chambers 9, 10 of the damping chamber 8 as a function of the direction of adjustment of the damping element 7 and/or the valve body 4. Preferably, this is carried out such that the degree of opening of the regulating gap 13 is less or more when the valve body 4 is adjusted from the open position into the closed position than when the valve body 4 is adjusted from the closed position into the open position. For example, the regulating element 19 can be pushed at least partially into the regulating gap 13, in order to reduce the degree of opening. The regulating gap 13 can be at least partially configured by the damping element 7 and/or the damping chamber 8.

The valve seat 18 is arranged between an inlet space 20 of a fluid and an outlet space 21 of the fluid, wherein the valve seat 18 opens in the direction of the outlet space 21. The valve body 4 is guided through the inlet space 20. The valve seat 18 thus represents the boundary between the inlet space 20 and the outlet space 21.

According to a variant of the valve 1 shown in FIGS. 7-9, it can be provided that the valve body 4 is guided with its free end 29 out of the outlet space 21, in particular is guided into an air-filled space 30 (air space) in which atmospheric pressure prevails. Thus no counterpressure acts from a line (outflow 25) arranged downstream of the outlet 5 on the valve body 4 during the adjustment thereof.

In the variant of the valve 1 shown in FIGS. 7-9 the air-filled space 30 is sealed relative to the outlet space 21 by an outlet space seal 28. The outlet space seal 28 can preferably be arranged on the valve body 4 and/or can be adjustable together with the valve body 4. The volume of the outlet space 21 and/or the air space 30 thus can vary in volume as a function of the position of the valve body 4.

The air-filled space 30 can be connected to the surroundings of the valve 1 by a compensation channel 31. Thus a continuous pressure compensation is possible inside the air space 30.

The compensation channel 31, as shown in FIGS. 7-9, can be at least partially configured by the valve body 4.

In particular, the compensation channel 31 can run through the valve seat 18 and/or the inlet space 20 and/or the outlet space 21. The compensation channel 31 is closed relative to the inlet space 20 and the outlet space 21, such that no fluid can penetrate into the compensation channel 31.

The embodiment shown in FIGS. 7-9 has the advantage that the valve body 4 is guided with its free end 29 out of the outlet space 21 and/or is located inside the air space 30. Thus no counterpressure or only a small amount of counterpressure acts from the outflow 25 on the valve body 4 when this is to be adjusted. In particular, therefore, it can be prevented that a counterpressure acting perpendicular to the adjusting direction of the valve body 4 occurs from the outflow.

The invention thus relates, in particular, to a valve 1, in particular a piston valve, comprising a stationary housing part 2 and an actuating element 3 which can be adjusted relative to the housing part 2 and is in, or can be brought into, an operative connection with a valve body 4, wherein the valve body 4 can be adjusted by way of actuation of the actuating element 3 between an open position which opens an outlet 5 and a closed position which closes the outlet 5, wherein the valve 1 has a damping device 6 for extending a closing time of the valve 1, by a damping force generated by the damping device counteracting an adjusting force applied for closing the valve 1.

### LIST OF REFERENCE NUMERALS

1 Valve

2 Stationary housing part

3 Actuating element

4 Valve body

5 Outlet

6 Damping device

7 Damping element

8 Damping chamber

9 First sub-chamber

10 Second sub-chamber

11 Push-push adjusting mechanism

12 Damping fluid

13 Regulating gap

14 Stop

15 Spring element

16 Restoring element

17 Valve piston

18 Valve seat

19 Regulating element

20 Inlet space

21 Outlet space

22 Actuating direction

23 Valve receiver

24 Further stationary housing part

25 Outflow

26 Sealing element

27 Inflow

28 Outlet space seal

29 Free end of valve body

30 Air-filled space

31 Compensation channel

32 Bypass

1. A valve (1), comprising:
a stationary housing part (2):
an actuating element (3) which is adjustable relative to the housing part (2) and which is in an operative connection with a valve body (4);
the valve body (4) is adjustable via actuation of the actuating element (3) between an open position which opens an outlet (5) and a closed position which closes the outlet (5);
a damping device (6) with a damping element (7) which is adjustable relative to at least one of the actuating element (3) or the stationary housing part (2);
at least a restoration of the valve body (4) from the open position into the closed position is damped by the damping device (6);
the valve body (4) is in an operative connection with the damping device (6); and
the valve body (4) adjustably acts on the damping device (6); and
at least in the open position the damping element (7) is spaced apart from a stop (14) formed by the stationary housing part (2), or at least in the closed position the damping element (7) bears against the stop (14) formed by the stationary housing part (2), or both.

2. The valve (1) as claimed in claim 1, wherein the damping device (6) has a damping chamber (8) in which the damping element (7) is arranged.

3. The valve (1) as claimed in claim 1, further comprising a push-push adjusting mechanism (11) which is actuatable by the actuating element (3).

4. The valve (1) as claimed in claim 1, wherein the damping device (6) has a damping fluid (12) which is displaceable or displaced by the damping element (7), at least when the valve body (4) is restored from the open position into the closed position.

5. The valve (1) as claimed in claim 2, further comprising a spring element (15) arranged inside the damping chamber (8), said spring element being at least one of compressed in the closed position of the valve (1) or being relaxed in the open position of the valve (1).

6. The valve (1) as claimed in claim 1, further comprising a restoring element (16) arranged such that, when adjusted from the closed position into the open position, the valve body (4) is adjustable or adjusted counter to a restoring force of the restoring element (16) of the valve (1), or the valve body (4) is restored from the open position into the closed position at least partially by the restoring force of the restoring element (16), or both.

7. The valve (1) as claimed in claim 1, wherein the valve body (4) has a valve piston (17) which at least one of (a) in the closed position closes a valve seat (18) of the valve (1) or (b) in the open position is adjusted out of the valve seat (18) in the direction of the outlet (5).

8. The valve (1) as claimed in claim 1, wherein the damping device (6) has at least one regulating element (19) by which a degree of opening of a regulating gap (13) between two sub-chambers (9, 10) of a damping chamber (8) is changeable or changed as a function of an adjusting direction of at least one of the damping element (7) or the valve body (4).

9. The valve (1) as claimed in claim 1, wherein when the valve body (4) is restored from the open position into the closed position, the damping element (7) is pushable or pushed by a force transmitted from the valve body (4) to the damping device (6) against a stop (14) or the damping element (7) is adjustable or adjusted relative to the damping chamber (8), or both.

10. The valve (1) as claimed in claim 1, wherein a valve seat (18) is arranged between an inlet space (20) of a fluid and an outlet space (21) of the fluid, the valve seat (18) opens in a direction of the outlet space (21), the valve body (4) is guided through the inlet space (20), and the valve body (4) is guided with a free end (29) thereof out of the outlet space (21).

11. The valve (1) as claimed in claim 1, wherein the damping device (6) provides for damped restoration of the valve body (4) from the open position into the closed position in order to avoid pressure surges.

12. (canceled)

13. The valve (1) as claimed in claim 2, wherein the damping element (7) divides the damping chamber (8) into two sub-chambers (9, 10), and respective volumes of said sub-chambers are changeable as a function of at least one of the closed position or the open position of the valve (1).

14. The valve (1) as claimed in claim 3, wherein a bistable adjustment of the valve body (4) takes place between the open position and the closed position in each case by pushing the actuating element (3).

15. The valve (1) as claimed in claim 4, wherein the damping fluid (12) is displaceable or displaced through at least one of a regulating gap (13) or a bypass (32) such that the damping fluid (12) is displaceable or displaced from one sub-chamber (10) into the other sub-chamber (9) of the damping chamber (8).

16. The valve (1) as claimed in claim 7, wherein the valve seat (18) is opened and/or widened in the direction of the outlet (5).

17. The valve (1) as claimed in claim 8, wherein the degree of opening of the regulating gap (13) is less when the valve body (4) is adjusted from the open position into the closed position than when the valve body (4) is adjusted from the closed position into the open position, or the regulating gap (13) is completely closed by the regulating element (19), and with an adjustment from the closed position into the open position the regulating element (19) opens the regulating gap (13).
